(19) United States
(12) Patent Application Publication
(10) Pub. No.: US 2025/0222786 A1
(43) Pub. Date: Jul. 10, 2025

(54) VEHICLE CONTROL SYSTEM

(71) Applicant: TOYOTA JIDOSHA KABUSHIKI KAISHA, Toyota-shi (JP)

(72) Inventor: Kumiko NODA, Toyota-shi (JP)

(73) Assignee: TOYOTAJIDOSHA KABUSHIKI KAISHA, Toyota-shi (JP)

(21) Appl. No.: 18/949,115

(22) Filed: Nov. 15, 2024

(30) Foreign Application Priority Data
Jan. 10, 2024 (JP) 2024-001766

(51) Int. Cl. B60L 15/20; B60L 1/00; B60L 58/16

(52) U.S. Cl. CPC B60L 15/2045; B60L 1/003; B60L 58/16

(57) ABSTRACT

There is provided a vehicle control system according to the present disclosure that controls a vehicle driven with electricity, the system including: an analysis unit that analyzes a deterioration factor of an electricity efficiency of the vehicle; an output unit that outputs one or more electricity efficiency improvement plans for improving the deterioration factor of the electricity efficiency; an acquisition unit that acquires any electricity efficiency improvement plan that is selected at an operation terminal out of the one or more electricity efficiency improvement plans output from the output unit; and a control unit that controls the vehicle based on a control content according to the electricity efficiency improvement plan acquired by the acquisition unit.

### CROSS-REFERENCE TO RELATED APPLICATION

This application claims priority to Japanese Patent Application No. 2024-001766 filed on Jan. 10, 2024, incorporated herein by reference in its entirety.

### BACKGROUND

### 1. Technical Field

The present disclosure relates to a vehicle control system.

### 2. Description of Related Art

It is being required to improve an electricity efficiency of a battery electric vehicle. Japanese Patent No. 7015395 discloses a vehicle that displays appropriate usage of the battery in accordance with the situation of use of the battery.

### SUMMARY

There has been a problem that the vehicle of Japanese Patent No. 7015395 merely displays the appropriate usage of the battery regardless of a demand of a user and cannot improve, in accordance with the demand of the user, usage of the battery.

The present disclosure is devised in view of the aforementioned background, and an object thereof is to provide a vehicle control system capable of improving an electricity efficiency of a vehicle in accordance with a demand of a user.

There is provided a vehicle control system according to the present disclosure that controls a vehicle driven with electricity, the system including: an analysis unit that analyzes a deterioration factor of an electricity efficiency of the vehicle; an output unit that outputs one or more electricity efficiency improvement plans for improving the deterioration factor of the electricity efficiency; an acquisition unit that acquires any electricity efficiency improvement plan that is selected at an operation terminal out of the one or more electricity efficiency improvement plans output from the output unit; and a control unit that controls the vehicle based on a control content according to the electricity efficiency improvement plan acquired by the acquisition unit. The vehicle control system controls the vehicle based on any selected by a user out of the one or more electricity efficiency improvement plans, output on a monitor or the like from the output unit, for improving the deterioration factor of the electricity efficiency. Thereby, the vehicle control system can improve the electricity efficiency of the vehicle in accordance with a demand of the user.

According to the present disclosure, there can be provided a vehicle control system capable of improving an electricity efficiency of a vehicle in accordance with a demand of a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration example of a vehicle control system having a vehicle control apparatus according to Embodiment 1 provided;

FIG. 2 is a flowchart showing operation of the vehicle control apparatus according to Embodiment 1;

FIG. 3 is a diagram showing an example of analysis results of a deterioration factor of an electricity efficiency by the vehicle control apparatus according to Embodiment 1;

FIG. 4 is a diagram showing an example of electricity efficiency improvement plans displayed on a monitor; and

FIG. 5 is a diagram showing an example of electricity efficiency improvement plans displayed on the monitor.

### DETAILED DESCRIPTION OF EMBODIMENTS

The present disclosure will be hereafter described with embodiments of the disclosure, and it is not intended to limit the disclosure according to the claims to the embodiments below. Moreover, the entire configurations described in the embodiments are not necessarily essential as the units for solving the problem. In the description and the drawings below, omission and simplification are properly made for clarifying explanation. In the drawings, the equivalent elements are given the equivalent signs, and their duplicate description is omitted as needed.

### Embodiment 1

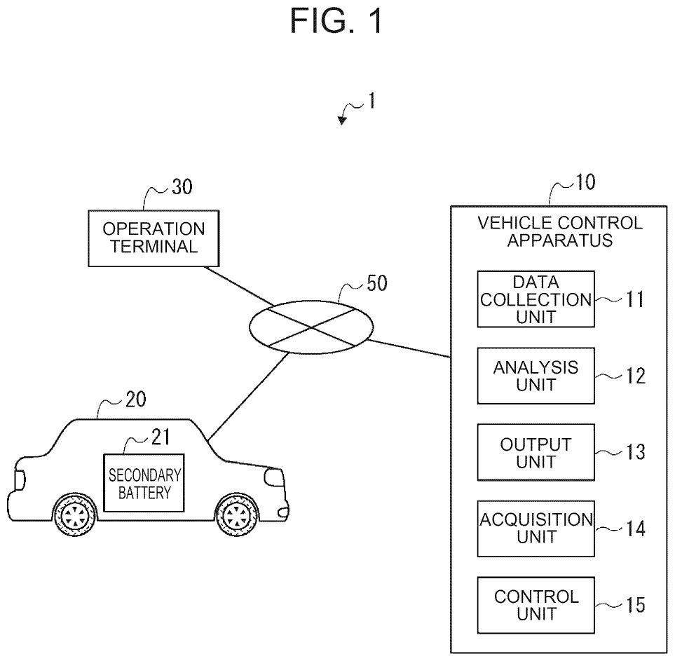

FIG. 1 is a diagram showing a configuration example of a vehicle control system 1 provided with a vehicle control apparatus according to Embodiment 1. The vehicle control system 1 according to the present embodiment can improve an electricity efficiency of a vehicle in accordance with a demand of a user by controlling the vehicle based on any selected by the user out of one or more electricity efficiency improvement plans, output on a monitor or the like, for improving a deterioration factor of the electricity efficiency. Specific description is hereafter made.

As shown in FIG. 1, the vehicle control system 1 includes a vehicle control apparatus 10, a vehicle 20, an operation terminal 30, and a network 50. The vehicle control apparatus 10, the vehicle 20, and the operation terminal 30 are configured to be communicable with one another via the wired or wireless network 50.

The vehicle 20 is a vehicle that is owned by a user U1 of the present system and driven with electricity, such as a battery electric vehicle. While in the present embodiment, there is exemplarily described a case where the vehicle 20 is a battery electric vehicle, not being limited to this, it may be a hybrid electric vehicle driven with electricity and gasoline. On the vehicle 20, a rechargeable secondary battery (battery) 21 such as a lithium-ion battery is mounted. The vehicle 20 is driven with electricity supplied from the secondary battery 21.

The operation terminal 30 is a communicable terminal that is owned by the user U1 or temporarily assigned to the user U1, being a terminal such as, for example, a personal computer (PC) terminal, a mobile terminal such as a smartphone or a tablet terminal, or a terminal of a car navigation system mounted on the vehicle 20.

The operation terminal 30 transmits information regarding a target electricity efficiency input by the user U1 to the vehicle control apparatus 10 via the network 50. Moreover, on a monitor of the operation terminal 30, an electricity efficiency deterioration factor and electricity efficiency improvement plans of the vehicle 20 output from the vehicle control apparatus 10 mentioned later are displayed, for example. For example, the user U1 selects any plan out of the electricity efficiency improvement plans displayed on the monitor of the operation terminal 30. The operation terminal 30 transmits the electricity efficiency improvement plan selected by the user U1 to the vehicle control apparatus 10 via the network 50. Note that the operation terminal 30 and the monitor may be separately provided.

The vehicle control apparatus 10 is an apparatus that improves the electricity efficiency of the vehicle 20 in accordance with a demand of the user U1 by controlling the vehicle 20 in accordance with the electricity efficiency improvement plan that is according to the demand of the user U1. Specifically, the vehicle control apparatus 10 includes a data collection unit 11, an analysis unit 12, an output unit 13, an acquisition unit 14, and a control unit 15. Note that the data collection unit 11, the analysis unit 12, the acquisition unit 14, and the control unit 15 may be provided in respective different apparatuses. In this case, these apparatuses construct a vehicle control system that implements functions of the vehicle control apparatus 10.

The data collection unit 11 collects information needed for calculating the electricity efficiency of the vehicle 20. From the information collected by the data collection unit 11, the electricity efficiency of the vehicle 20 is calculated. The electricity efficiency of the vehicle 20 is a travelling distance (km) of the vehicle 20 per 1 kWh. Moreover, the data collection unit 11 collects information regarding the deterioration factor of the electricity efficiency of the vehicle 20. Specifically, the data collection unit 11 collects, as the information regarding the deterioration factor of the electricity efficiency, a frequency of rapid acceleration, a frequency of rapid deceleration, a frequency of rapid charge, the degree of deterioration of a capacity of the secondary battery 21, a payload, an amount of air conditioner use, and the like. Furthermore, the data collection unit 11 collects information regarding a peripheral environment of the vehicle 20. Specifically, the data collection unit 11 collects, as the information regarding the peripheral environment of the vehicle 20, the weather (information such as a cold region or a tropical region) in a travelling area of the vehicle 20, a traffic situation (information such as travelling or not in an urban part of frequent congestion), a ratio of slopes, a ratio of curves, a state of pavement, and the like. The information regarding the peripheral environment of the vehicle 20 may be collected from an external device such as a GPS and/or may be acquired from the operation terminal 30 based on an operation of the user U1. Note that the data collection unit 11 also collects similar information to that in the case of the vehicle 20, from a plurality of not-shown vehicles other than the vehicle 20. For example, all the vehicles other than the vehicle 20 are vehicles of equivalent vehicle type to that of the vehicle 20, not being limited to these.

When the electricity efficiency of the vehicle 20 does not reach the target electricity efficiency, the analysis unit 12 analyzes the deterioration factor of the electricity efficiency of the vehicle 20 using the data collected by the data collection unit 11. For example, the analysis unit 12 calculates individual indices (deviation values) of a plurality of electricity efficiency deterioration factors of the vehicle 20 by comparing the vehicle 20 and the other vehicles with each other. Specifically, the analysis unit 12 calculates, on the vehicle 20, individual indices (deviation values) of the frequency of rapid acceleration, the frequency of rapid deceleration, the frequency of rapid charge, the degree of deterioration of the capacity of the secondary battery 21, the payload, the amount of air conditioner use, and the like. Then, the analysis unit 12 extracts, as an electricity efficiency deterioration factor to be improved, an electricity efficiency deterioration factor that shows a higher index than a predetermined threshold, out of the electricity efficiency deterioration factors of the vehicle 20.

Note that the analysis unit 12 may further calculate a contribution ratio of an amount of electric power loss of each electricity efficiency deterioration factor. Here, the contribution ratio of the amount of electric power loss of each electricity efficiency deterioration factor means a ratio of the amount of electric power loss of the electricity efficiency deterioration factor relative to the total of the amounts of electric power loss of all the electricity efficiency deterioration factors. Moreover, the amount of electric power loss of each electricity efficiency deterioration factor means a difference between an amount of electric power consumption of the vehicle 20 and a market average as for the electricity efficiency deterioration factor. By improving the electricity efficiency deterioration factor that has a high contribution ratio of the amount of electric power loss, the electricity efficiency can be effectively restrained.

Moreover, the analysis unit 12 may extract the electricity efficiency deterioration factor to be improved, in consideration of the peripheral environment of the vehicle 20. For example, since there is a high possibility of difficulty in reducing the air conditioner use when the travelling area of the vehicle 20 is a cold region, the analysis unit 12 may exclude the amount of air conditioner use from the electricity efficiency deterioration factor to be improved, even when the index of the amount of air conditioner use is higher than a predetermined threshold. Otherwise, when the travelling area of the vehicle 20 is a cold region, the analysis unit 12 may adjust the threshold that is set for the amount of air conditioner use to be a higher value. Moreover, for example, since there is a high possibility of difficulty in reducing the frequency of rapid acceleration when the travelling area of the vehicle 20 is an area of many slopes, the analysis unit 12 may exclude the frequency of rapid acceleration from the electricity efficiency deterioration factor to be improved, even when the index of the frequency of rapid acceleration is higher than a predetermined threshold. Otherwise, when the travelling area of the vehicle 20 is an area of many slopes, the analysis unit 12 may adjust the threshold that is set for the frequency of rapid acceleration to be a higher value.

The output unit 13 outputs one or more electricity efficiency improvement plans with respect to the electricity efficiency deterioration factor to be improved that is extracted by the analysis unit 12. The electricity efficiency improvement plan may be derived through analysis by the analysis unit 12 or may be extracted from a database having combinations of electricity efficiency deterioration factors and their improvement plans stored.

For example, when the amount of air conditioner use is excessive, the output unit 13 outputs an electricity efficiency improvement plan of restricting the amount of air conditioner use to be not more than a predetermined amount (or an electricity efficiency improvement plan of providing notification to encourage the restriction). Moreover, when the frequency of rapid deceleration is excessive, the output unit 13 outputs an electricity efficiency improvement plan of gradually decelerating the vehicle 20 in accordance with distances from a stop-line and a front vehicle (or an electricity efficiency improvement plan of providing notification to encourage the gradual deceleration). Moreover, when the frequency of rapid charge of the secondary battery 21 is excessive, the output unit 13 outputs an electricity efficiency improvement plan of restricting the frequency of rapid charge of the secondary battery 21 to be not more than a predetermined frequency (or an electricity efficiency improvement plan of providing notification to encourage the restriction). Moreover, when the deterioration of the capacity of the secondary battery 21 is excessive, the output unit 13 outputs an electricity efficiency improvement plan of restraining the deterioration of the secondary battery 21, for example, by keeping a temperature of the secondary battery 21 to be not more than a predetermined temperature, or the similar plan.

Note that the output unit 13 may output the electricity efficiency deterioration factor to be improved along with the electricity efficiency improvement plan. Moreover, the output unit 13 may further output the contribution ratio of the amount of electric power loss of each electricity efficiency deterioration factor. Moreover, the output unit 13 may output the target electricity efficiency of the vehicle 20 and the calculation result of the electricity efficiency of the vehicle 20. Furthermore, the output unit 13 may further output the degree of recommendation according to the peripheral environment of the vehicle 20 for each of the one or more electricity efficiency improvement plans.

These pieces of information output from the output unit 13 are displayed, for example, on the monitor of the operation terminal 30. When the monitor is separately provided from the operation terminal 30, these are displayed on the monitor separately provided from the operation terminal 30. Otherwise, these pieces of information output from the output unit 13 may be output from another output apparatus other than a monitor, for example, be output as voice from a loudspeaker.

When the output unit 13 further outputs the degree of recommendation according to the peripheral environment of the vehicle 20 for each of the one or more electricity efficiency improvement plans, on the monitor of the operation terminal 30, pairs of the electricity efficiency improvement plans and the degrees of recommendation may be displayed, the electricity efficiency improvement plan that is high in degree of recommendation may be emphasized, and/or the electricity efficiency improvement plan that is low in degree of recommendation may be displayed not to be able to be selected.

By operating the operation terminal 30, the user U1 selects any plan of the one or more electricity efficiency improvement plans displayed on the monitor or the like. The operation terminal 30 transmits the electricity efficiency improvement plan selected by the user U1 to the vehicle control apparatus 10 via the network 50. Here, the electricity efficiency improvement plan can be regarded as a control content (control mode) of the vehicle 20 for improving the electricity efficiency.

In the vehicle control apparatus 10, the acquisition unit 14 acquires the electricity efficiency improvement plan transmitted from the operation terminal 30. The control unit 15 controls the vehicle 20 based on the control content according to the electricity efficiency improvement plan acquired by the acquisition unit 14.

As above, the vehicle control system 1 according to the present embodiment controls the vehicle based on any selected by the user out of the one or more electricity efficiency improvement plans output on the monitor or the like, and thereby, can improve the electricity efficiency of the vehicle in accordance with a demand of the user. As a result, the user can obtain feeling of acceptance with respect to the electricity efficiency improvement of the vehicle. Moreover, since the tendency in driving of the user themself can be grasped from the electricity efficiency improvement plans provided by the vehicle control apparatus 10, the user can improve their own driving.

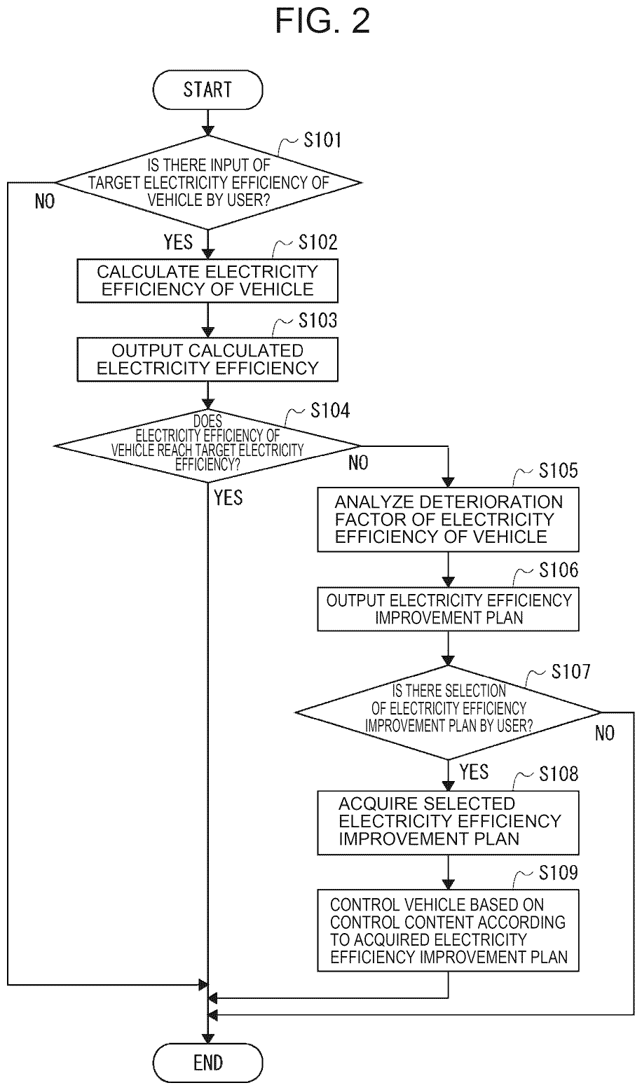

Next, using FIG. 2, operation of the vehicle control apparatus 10 is described. FIG. 2 is a flowchart showing operation of the vehicle control apparatus 10.

First, when acquiring the information regarding the target electricity efficiency of the vehicle 20 input to the operation terminal 30 by the user U1 (YES in step S101), the vehicle control apparatus 10 calculates the electricity efficiency of the vehicle 20 (step S102). Then, the vehicle control apparatus 10 outputs the calculation result of the electricity efficiency of the vehicle 20 and the target electricity efficiency of the vehicle 20 (step S103). The calculation result of the electricity efficiency of the vehicle 20 and the target electricity efficiency of the vehicle 20, output from the vehicle control apparatus 10, are displayed, for example, on the monitor of the operation terminal 30.

When the information regarding the target electricity efficiency of the vehicle 20 is not acquired (NO in step S101), the vehicle control apparatus 10 does not perform control of electricity efficiency improvement of the vehicle 20.

After the calculation of the electricity efficiency of the vehicle 20, when the electricity efficiency of the vehicle 20 reaches the target electricity efficiency (YES in step S104), that is, when the electricity efficiency of the vehicle 20 is not less than the target electricity efficiency, the vehicle control apparatus 10 does not perform control of electricity efficiency improvement of the vehicle 20. In contrast, when the electricity efficiency of the vehicle 20 does not reach the target electricity efficiency (NO in step S104), that is, when the electricity efficiency of the vehicle 20 is less than the target electricity efficiency, control of electricity efficiency improvement of the vehicle 20 is performed.

Specifically, first, the vehicle control apparatus 10 analyzes the electricity efficiency deterioration factor of the vehicle 20 (step S105). For example, the vehicle control apparatus 10 calculates the individual indices (deviation values) of the electricity efficiency deterioration factors of the vehicle 20 by comparing the vehicle 20 and the other vehicles with each other. Specifically, the vehicle control apparatus 10 calculates, on the vehicle 20, the individual indices (deviation values) of the frequency of rapid acceleration, the frequency of rapid deceleration, the frequency of rapid charge, the degree of deterioration of the capacity of the secondary battery 21, the payload, the amount of air conditioner use, and the like. Then, the vehicle control apparatus 10 extracts, as an electricity efficiency deterioration factor to be improved, an electricity efficiency deterioration factor that shows a higher index than a predetermined threshold, out of the electricity efficiency deterioration factors of the vehicle 20.

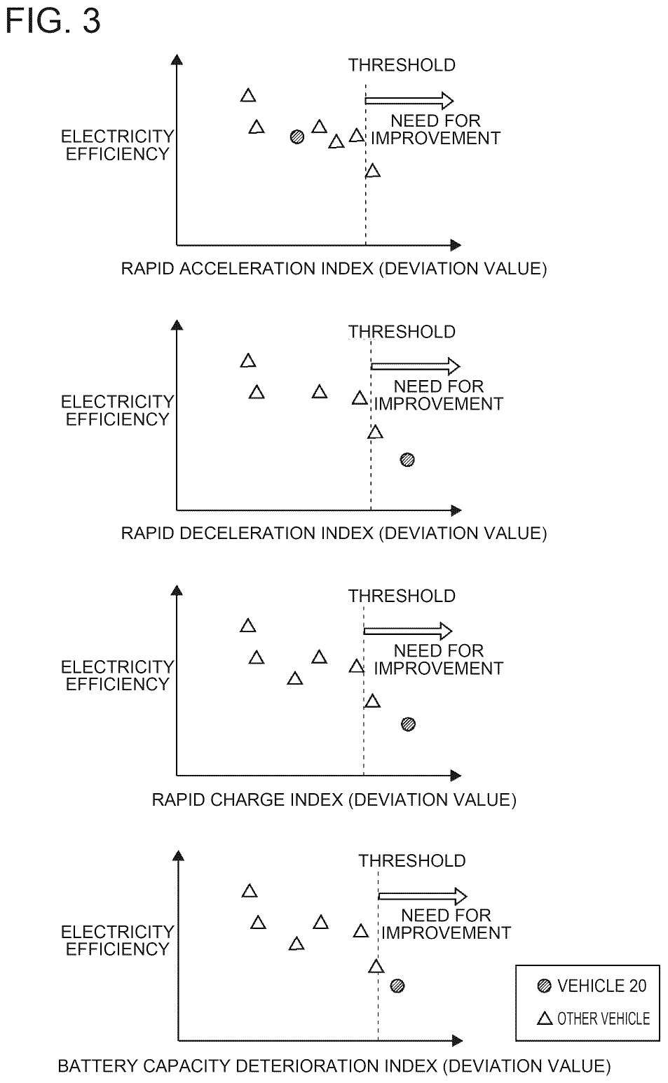

FIG. 3 is a diagram showing an example of analysis results of the electricity efficiency deterioration factors by the vehicle control apparatus 10. Therefore, in the example of FIG. 3, there are shown relationship between the frequency of rapid acceleration and the electricity efficiency, relationship between the frequency of rapid deceleration and the electricity efficiency, relationship between the frequency of rapid charge and the electricity efficiency, and relationship between the degree of deterioration of the battery capacity and the electricity efficiency. In the example of FIG. 3, while the index of the frequency of rapid acceleration of the vehicle 20 is not more than the predetermined threshold, the index of the frequency of rapid deceleration, the index of the frequency of rapid charge, and the index of the degree of deterioration of the battery capacity on the vehicle 20 show higher values than the predetermined thresholds. Accordingly, in the example of FIG. 3, there are three electricity efficiency deterioration factors to be improved, out of four electricity efficiency deterioration factors.

After that, the vehicle control apparatus 10 outputs one or more electricity efficiency improvement plans with respect to the electricity efficiency deterioration factor to be improved (step S106).

For example, the vehicle control apparatus 10 outputs an electricity efficiency improvement plan of restricting the frequency of rapid deceleration of the vehicle 20, an electricity efficiency improvement plan of restricting the frequency of rapid charge of the secondary battery 21 to be not more than a predetermined frequency, and an electricity efficiency improvement plan of restraining the deterioration of the secondary battery 21, for example, by keeping the temperature of the secondary battery 21 to be not more than a predetermined temperature. These electricity efficiency improvement plans output from the vehicle control apparatus 10 are displayed, for example, on the monitor of the operation terminal 30.

When any electricity efficiency improvement plan out of the one or more electricity efficiency improvement plans displayed on the monitor is selected by the user U1 (YES in step S107), the vehicle control apparatus 10 acquires the selected electricity efficiency improvement plan (step S108), and controls the vehicle 20 based on the control content according to the acquired electricity efficiency improvement plan (step S109). When any electricity efficiency improvement plan is not selected by the user U1 (NO in step S107), the vehicle control apparatus 10 does not perform control of electricity efficiency improvement of the vehicle 20.

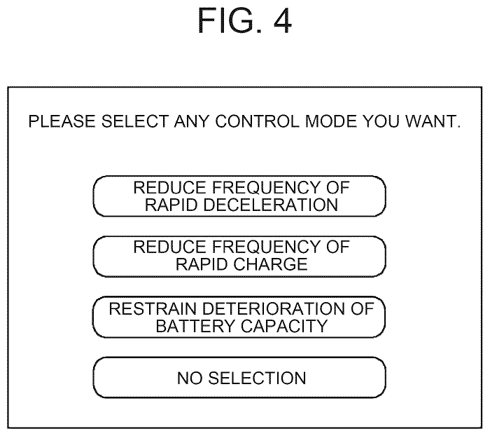

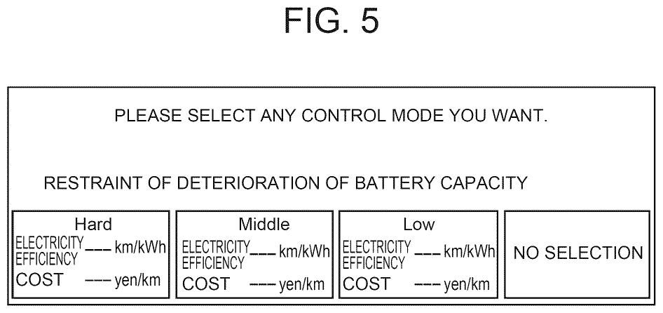

FIG. 4 and FIG. 5 are diagrams showing examples of the electricity efficiency improvement plans displayed on the monitor. First, in the example of FIG. 4, there are shown an electricity efficiency improvement plan of restricting the frequency of rapid deceleration of the vehicle 20, an electricity efficiency improvement plan of restricting the frequency of rapid charge of the secondary battery 21 to be not more than a predetermined frequency, and an electricity efficiency improvement plan of restraining the deterioration of the secondary battery 21. For example, the user U1 selects the electricity efficiency improvement plan of restricting the deterioration of the secondary battery 21. Note that the user U1 may select electricity efficiency improvement plans.

Then, in the example of FIG. 5, there are shown electricity efficiency improvement plans with strengths for restraining the deterioration of the secondary battery 21. The user U1 can select the electricity efficiency improvement plan with a desired strength out of the electricity efficiency improvement plans with the strengths for restraining the deterioration of the secondary battery 21. In other words, in order to restrain the deterioration of the secondary battery 21, the user U1 can adjust, for example, a ratio at which the temperature of the secondary battery 21 is kept to be not more than the predetermined temperature. For example, when the electricity efficiency improvement plan with a large strength is selected, in order to restrain the deterioration of the secondary battery 21, the vehicle control apparatus 10 controls the vehicle 20, for example, so as to keep the temperature of the secondary battery 21 always to be not more than the predetermined temperature. In contrast, when the electricity efficiency improvement plan with a small strength is selected, the vehicle control apparatus 10 controls the vehicle 20, for example, to reduce the ratio at which the temperature of the secondary battery 21 is kept to be not more than the predetermined temperature.

As above, the vehicle control apparatus 10 according to the present embodiment controls the vehicle based on any selected by the user out of the one or more electricity efficiency improvement plans output on the monitor or the like, and thereby, can improve the electricity efficiency of the vehicle in accordance with the demand of the user. As a result, the user can obtain feeling of acceptance with respect to the electricity efficiency improvement of the vehicle. Moreover, since the tendency in driving of the user themself can be grasped from the electricity efficiency improvement plans provided by the vehicle control apparatus 10, the user can improve their own driving.

Moreover, a part or the entirety of the processing of the vehicle control apparatus 10 of the present disclosure can be implemented by causing a central processing unit (CPU) to execute a computer program.

The program includes a group of commands (or software codes) for causing a computer to perform one or more of the functions described in the embodiment when being read into the computer. The program may be stored in a non-transitory computer-readable medium or a substantial storage medium. Not-limiting examples of the computer-readable medium or the substantial storage medium include a random-access memory (RAM), a read-only memory (ROM), a flash memory, a solid-state drive (SSD), or another memory technology, a CD-ROM, a digital versatile disc (DVD), a Blu-ray® disc, or another optical disc storage, and a magnetic cassette, a magnetic tape, a magnetic disk storage, or another magnetic storage device. The program may be transmitted on a transitory computer-readable medium or a communication medium. Not-limiting examples of the transitory computer-readable medium or the communication medium include transmission signals of electric, optical, acoustic, or another type.

A part or the entirety of the embodiment above can be described as in the following supplements, not being limited to these.

### Supplement 1

A vehicle control method for a vehicle control system controlling a vehicle driven with electricity, the method including:
analyzing a deterioration factor of an electricity efficiency of the vehicle;
outputting one or more electricity efficiency improvement plans for improving the deterioration factor of the electricity efficiency;
acquiring any electricity efficiency improvement plan that is selected at an operation terminal out of the output one or more electricity efficiency improvement plans; and
controlling the vehicle based on a control content according to the acquired electricity efficiency improvement plan.

### Supplement 2

A control program that causes a computer to execute vehicle control processing of controlling a vehicle driven with electricity, the control program causing the computer to execute:
processing of analyzing a deterioration factor of an electricity efficiency of the vehicle;
processing of outputting one or more electricity efficiency improvement plans for improving the deterioration factor of the electricity efficiency;
processing of acquiring any electricity efficiency improvement plan that is selected at an operation terminal out of the output one or more electricity efficiency improvement plans; and
processing of controlling the vehicle based on a control content according to the acquired electricity efficiency improvement plan.

What is claimed is:

1. A vehicle control system that controls a vehicle driven with electricity, the system comprising:
an analysis unit that analyzes a deterioration factor of an electricity efficiency of the vehicle;
an output unit that outputs one or more electricity efficiency improvement plans for improving the deterioration factor of the electricity efficiency;
an acquisition unit that acquires any electricity efficiency improvement plan that is selected at an operation terminal out of the one or more electricity efficiency improvement plans output from the output unit; and
a control unit that controls the vehicle based on a control content according to the electricity efficiency improvement plan acquired by the acquisition unit.

2. The vehicle control system according to claim 1, wherein the analysis unit analyzes the deterioration factor of the electricity efficiency based on at least any of a frequency of rapid acceleration, a frequency of rapid deceleration, a frequency of rapid charge, a degree of deterioration of a battery capacity, a payload, and an amount of air conditioner use.

3. The vehicle control system according to claim 1, wherein the output unit further outputs information regarding the deterioration factor of the electricity efficiency.

4. The vehicle control system according to claim 1, wherein:
the acquisition unit further acquires information regarding a target electricity efficiency of the vehicle via the operation terminal; and
the analysis unit analyzes the deterioration factor of the electricity efficiency of the vehicle when the electricity efficiency of the vehicle deteriorates more than the target electricity efficiency.

5. The vehicle control system according to claim 1, wherein:
the acquisition unit further acquires information regarding a peripheral environment of the vehicle; and
the output unit further outputs a degree of recommendation according to the peripheral environment of the vehicle for each of the one or more electricity efficiency improvement plans for improving the deterioration factor of the electricity efficiency.
